(19) United States
(12) Patent Application Publication
(10) Pub. No.: US 2007/0179898 A1
(43) Pub. Date: Aug. 2, 2007

(54) Secure consumer distribution of content using subkeys for encryption and authentication

(75) Inventors: Alexander Medvinsky, San Diego, CA (US); Eric Sprunk, Carlsbad, CA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(73) Assignee: General Instrument Corporation, Horsham, PA (US)

(21) Appl. No.: 11/347,704

(22) Filed: Feb. 2, 2006

(51) Int. Cl. H04L 9/00

(52) U.S. Cl. 705/59

(57) ABSTRACT

User-to-user (“superdistribution”) of digital content allows for management and control of the distribution by a content owner, content distributor or other owner or licensee of the content. Provisions are also available for identifying senders and receivers of content for purposes of compensating or encouraging distribution. A sending user generates a referral key that is used to encrypt all, or a portion of, the content, or to encrypt other mechanisms (e.g., another key, ticket, etc.) that will ultimately be used to allow access to the content. The sending user creates a content referral object that includes the restricted referral key, an identification of the license server and an identification of the content. A receiving user receives the content referral object and contacts the license server to identify the transaction (e.g., content being referred, access rights desired, etc.) and to receive information (e.g., a key or ticket) to use the referral key to access the content.

### CROSS- REFERENCES TO RELATED APPLICATIONS

This application is related to the following co-pending U.S. Patent Applications which are hereby incorporated by reference as if set forth in full in this specification:

Ser. No. 10/334,606, filed on Dec. 30, 2002, entitled “SYSTEM FOR DIGITAL RIGHTS MANAGEMENT USING DISTRIBUTED PROVISIONING AND AUTHENTICATION;” and

Ser. No. 10/613,868, filed on Jul. 5, 2003, entitled “ENFORCEMENT OF PLAYBACK COUNT IN SECURE HARDWARE FOR PRESENTATION OF DIGITAL PRODUCTIONS”

### BACKGROUND OF THE INVENTION

1. Field of the Invention

This invention relates in general to transfer of information over digital networks and more specifically to controlling the distribution of content by consumers, or end-users.

2. Description of the Background Art

Today's digital systems deal with many types of information, or content, used in commerce, education, entertainment, banking, government, etc. Often, such information is transferred over a digital network such as the Internet, local-area network (LAN), campus or home network, or other communication link or scheme. Digital transfer of content provides an extremely fast and cost-efficient way to distribute content at the retail level, to consumers, or end-users. “Superdistribution” of content, i.e., consumer-to-consumer distribution, is also possible and can result in very high volume distribution at low, or no, cost to the original content owner, or commercial distributor.

Typically, a content owner, authorized distributor or other “content provider” has a commercial interest in restricting the distribution or use of the content provider's proprietary content. The content provider desires to increase authorized, or paid, distribution while at the same time preventing unauthorized, or unpaid, distribution. For example, owners of digital content, such as a movie or song, may wish to restrict a user from playing back the audio or video content if the user has not properly paid for, or subscribed to, such use. Some forms of limited restriction are also useful, such as when a superdistributed copy of a promotional video can be freely distributed without payment for advertising purposes, but promotional video playback is limited to only a portion of the full video, or is at a lower resolution than the “paid for” version of the video. A consumer can decide to purchase the full version of the video as a result of seeing the promotional video.

However, one problem with digital distribution of content, especially where superdistribution is concerned, is that unauthorized consumer-to-consumer exchange of content can result in lost sales and profit. Part of this problem is due to the ease that digital content can be copied. Since the playback devices are usually under the control of the consumer, the content is prone to an “attack” or “hacking” or other unauthorized use. Also, electronic distribution over the Internet means that different forms of the content may pass through many different hardware systems and communication links, many of which will be beyond the control of a content provider who desires to restrict the content.

In a traditional approach to superdistribution an encrypted copy of the content is copied, as is, from a first consumer to a second consumer. When the second consumer decides to purchase this content, the second consumer purchases a license from a content provider. The license contains the decryption key for the content. Inside the license, the decryption key is encrypted with the second consumer's public key.

However, a problem with this approach is that once the decryption key for the content is somehow discovered and possibly published on the Internet, superdistribution has been broken and the content owner may start losing revenue. Since the same copy of the encrypted content is shared between all the consumers, one cannot trace the copy of the content to a particular consumer that compromised the decryption key and the content provider is helpless to take action to preserve ownership rights.

With the prior art superdistribution approach the same content decryption key is shared not only between all users of the superdistributed copies, but between all users of the same piece of content and also with the content provider. Typically, the content provider maintains a central database of all of the content decryption keys. However, the large number of keys required for mass distribution of content can make maintenance of such a database cumbersome and costly. Also, the database, itself, presents a vulnerable attack point in the superdistribution approach.

### SUMMARY OF EMBODIMENTS OF THE INVENTION

An embodiment of the invention provides for superdistribution of digital content allowing for management and control of the distribution by a content owner, content distributor or other owner or licensee of the content. Provisions are also available for identifying senders and receivers of content for purposes of compensating or encouraging distribution.

In a preferred embodiment a sending user that has present rights to content generates a referral key that is used to encrypt all, or a portion of, the content, or to encrypt other mechanisms (e.g., another key) that will ultimately be used to allow access to the content. The referral key is further encrypted or restricted from use unless information is obtained from a third-party server such as a license server. The sending user creates a content referral object that includes the restricted referral key, an identification of the license server and an identification of the content. A receiving user receives the content referral object and contacts the license server to identify the transaction (e.g., content being referred, access rights desired, etc.) and to receive information (e.g., a key) to use the referral key to access the content.

In one embodiment additional information can be provided by the sending user such as to identify the sending user for purposes of compensation, reward, or other incentive, or to otherwise track referrals. The actual content can be transferred by the sending user to the receiving user. Or the content can be stored on a third device, such as an origin server, and can be merely identified in the content referral object.

One feature provides for some of the content to be “clear” or unencrypted. This allows the receiving user to preview the content to decide whether to purchase the remainder of this content.

In one embodiment the invention provides a method for distributing digital content, the method using a first user device in communication with a second user device and a server, the method comprising using the first user device to generate a referral key; securing the referral key so that the referral key can not be used unless information is obtained from the server; creating an identifier for identifying the digital content; and sending the secured referral key and the identifier to the second user device.

### BRIEF DESCRIPTION OF THE DRAWINGS

FIG. 1 shows components in an Internet Protocol Rights Management (IPRM) system suitable for use with the present invention;

FIG. 2 shows additional components relating to home domain access of information provided by a DRM system such as the IPRM system of FIG. 1;

FIG. 3 illustrates basic features of a superdistribution system;

FIG. 4 is a diagram showing attributes of a persistent entitlement element in a preferred embodiment of the invention; and

FIG. 5 is a diagram showing attributes of an option cost element in a preferred embodiment of the invention.

### DETAILED DESCRIPTION OF EMBODIMENTS OF THE INVENTION

A preferred embodiment of the invention is used with a specific digital rights management (DRM) architecture that is discussed in the related patents, cited above. This architecture is referred to as an Internet Protocol Rights Management (IPRM) system. It should be apparent that different embodiments can use different DRM architectures and features than those discussed herein and in the related patent applications. Different logical and/or physical components than those discussed for the IPRM can be used. Not all components need to be used in any given DRM architecture, and additional components, interconnections, functions and working relationships can be employed.

A preferred embodiment of the invention also uses a specific protocol developed by Motorola, Inc., referred to as ESBroker. It should be apparent that other protocols, syntax and techniques can be used in alternative embodiments. For example, features similar to those in the Kerberos authentication service developed by the Massachusetts Institute of Technology can be employed. Other features of other authentication or security systems can be used.

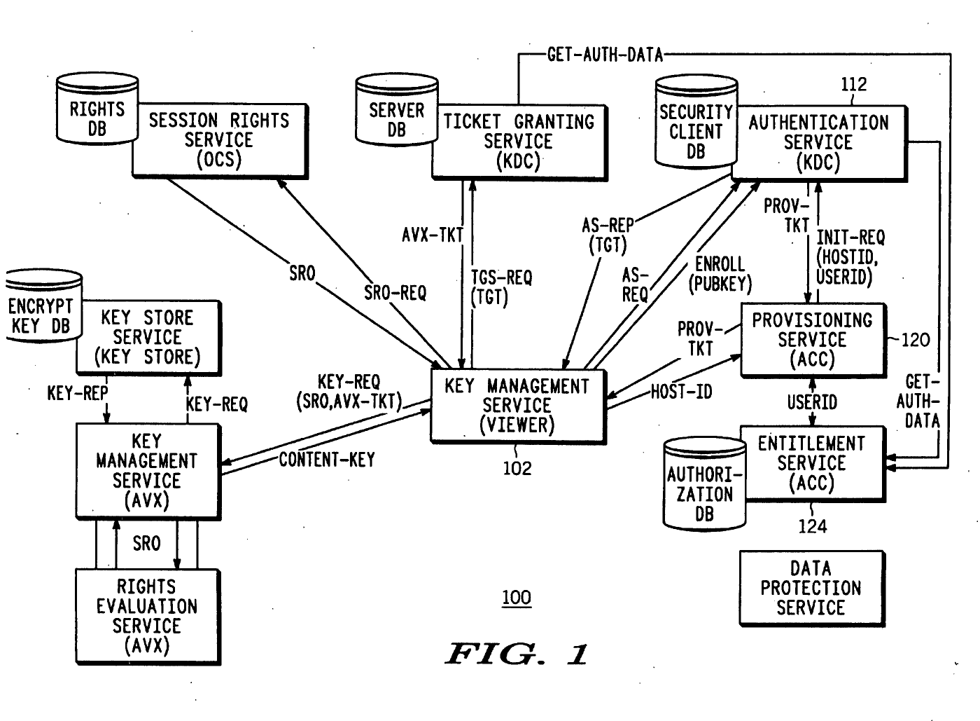

FIG. 1 shows components in an Internet Protocol Rights Management (IPRM) system suitable for use with the present invention.

In FIG. 1, logical components are shown in boxes with an indication of the physical component that is, preferably, used to perform the functionality of the logical component in parenthesis. Note that FIG. 1 is merely a broad, general diagram of a one content distribution system. The functionality represented by logical components can vary from that shown in FIG. 1 and still remain within the scope of the invention. Logical components can be added, modified or removed from those shown in FIG. 1. The physical components are examples of where logical components described in the diagram could be deployed. In general, aspects of the present invention can be used with any number and type of devices interconnected by a digital network.

FIG. 1 shows interfaces in the IPRM designed for secure content distribution and for the enforcement of rights of content and service providers. Such a system is used, for example, with satellite and cable television distribution channels where standard television content, along with digital information such as files, web pages, streaming media, etc., can be provided to an end user at home via a set-top box. IPRM system 100 is illustrated using a few exemplary logical components. In an actual system, there will be many more instances of specific logical components. For example, key management service 102 is intended to execute at a user, or viewer location. Naturally, there will be millions of viewers in a typical cable television network.

The general purpose and operation of various of the entities of FIG. 1, such as provisioning service (PS) 120, authentication service (AS) 112, entitlement service 124, client processors and other servers and devices are well-known in the art. A system such as that shown in FIG. 1 is discussed in more detail in co-pending patent application SYSTEM FOR DIGITAL RIGHTS MANAGEMENT USING DISTRIBUTED PROVISIONING AND AUTHENTICATION, referenced above. The device security ratings system of the present invention can be used among any of the components and physical and logical devices shown in FIG. 1 so that a decision can be made whether to transfer content, or other information, from an inquiring device to a target device.

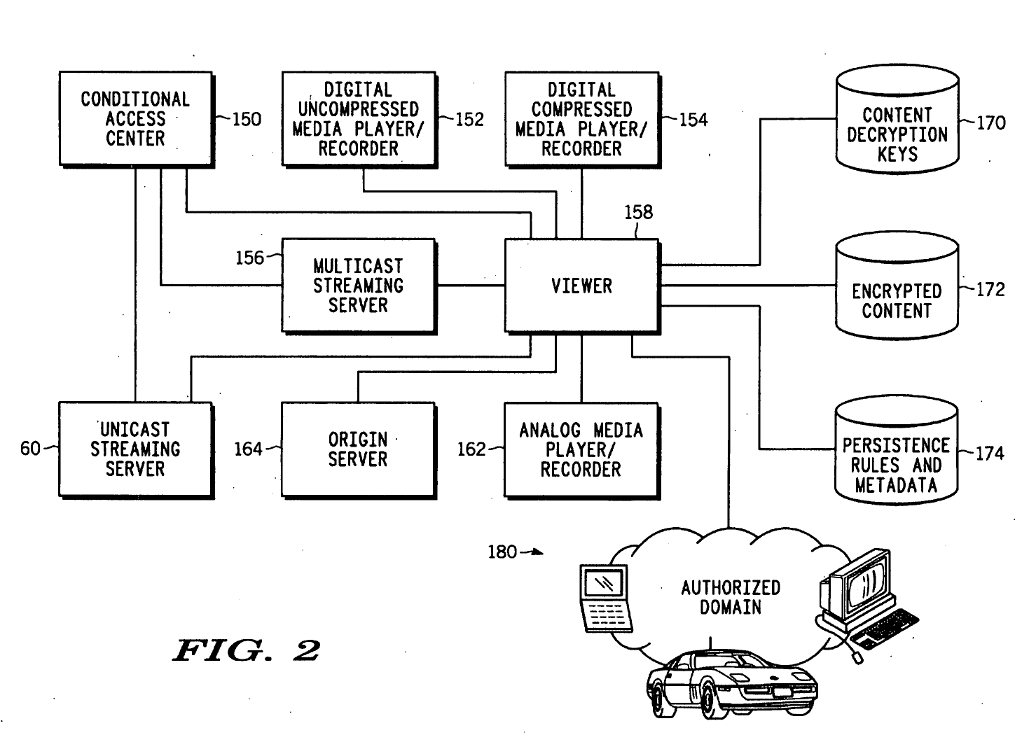

FIG. 2 shows additional components relating to home domain access of information provided by a DRM system such as the IPRM system of FIG. 1. The system of FIG. 2 can be considered as a subsystem, additional system, or overlay to that of FIG. 1. Although FIG. 2 shows hardware devices, such devices (e.g., viewer 158) can perform portions or combinations of the functions or services described in FIG. 1.

In FIG. 2, viewer 158 can be a display device, audio playback device, or other media presentation device, such as a television or computer. Viewer 158 is associated with local playback devices for playback of content, such as uncompressed digital media player 152, compressed digital media player 154 and analog media player 162. Such local devices are part of an “authorized domain” of equipment that is easily accessed by a user, or consumer, as illustrated by devices at 180. Note that the authorized domain can include additional networks, such as Ethernet, wireless, home phone network adapter (PNA), etc. and any number and types of devices for accessing, transferring, playing, creating, and managing content.

The authorized domain presents a security risk to a content provider since it typically places content directly at the control of a user. As indicated in FIG. 2, various devices may provide a user with content in various formats such as uncompressed, compressed, analog, stored, encrypted, etc. Other ways to provide content to the viewer are from remote devices such as conditional access center 150 using multicast streaming server 156 or unicast streaming server 160. Origin server 164 typically provides information about available content as well as links to streaming or file download servers from which the content can be obtained.

Information can be stored locally or remotely from the authorized domain. Sensitive information such as content decryption keys 170, encrypted content 172 and rules and metadata 174 might commonly be stored in devices that are accessible by the user. Cryptographic keys are preferably protected by a security chip inside a user device.

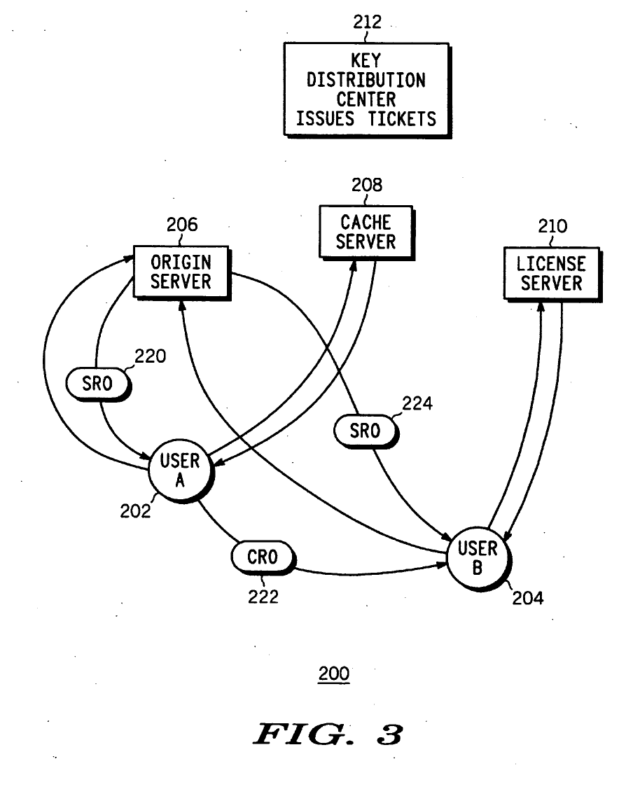

FIG. 3 illustrates entities and services used in superdistribution system 200 according to one embodiment of the invention. The approach shown in FIG. 3 is illustrative of some of the basic steps in one embodiment. Other embodiments can use variations including omitting, adding or changing services, entities and relationships among services and entities. The example of FIG. 3 can be implemented using components and devices such as those discussed above in connection with FIGS. 1 and 2, or other hardware and/or software.

In FIG. 3, User_A 202 represents a digital processing system capable of storing or transferring digital content that is belongs to a customer A. For example, suitable digital processing systems can be devices such as personal or portable computers, a cell phone, personal digital assistant, pager, email device, audio player, etc. In general, any device capable of storing or transferring information can be used. User_B 204 represents a similar device that is associated with the ownership by a another customer. For this purpose, a customer may be a single human user, a household or an enterprise such as a bar that provides audiovisual entertainment to its own customers.

User_A registers with Key Distribution Server 212 and obtains a “principal name”. The principal name can be, e.g., a user name, log on name, or other type of customary alphanumeric name or identifier. In a preferred approach, a device identifier taken from a digital certificate in the device is used as the principal name. Using a device identifier provides more automation to the registration process—since device identifier comes from a digital certificate that is signed by a trusted PKI authority, that device identifier can be used directly without a manual verification step. As is known in the art, Key Distribution Server 212 associates the principal name with a key, or other information, so that authentication can be performed. For example, asymmetric or symmetric keys can be used with a Kerberos-type key distribution server.

User_A obtains content, such as a digital song, video, etc., from Cache Server 208. Cache Server 208 can be operated by a content owner or a third party content distributor. A copy of the content can be transferred directly to User_A's device, such as where an .mp3 format audio file is sent over the Internet, or other network. Other ways of transferring the content are possible such as mailing physical media (e.g., a compact-disc read-only memory (CDROM), digital versatile disk (DVD), memory stick, etc.). An alternative to direct transfer of content is to allow the content to reside at a location different from User_A's device and to allow User_A's device to access the content. For example, the content can remain on the Cache Server (which is capable of streaming)and streamed to User_A's device “on demand” each time as User_A desires access to the content, such as to play back a video program.

Regardless of where the actual content information resides, User_A must obtain a license, or rights, to access and play back the content. In a preferred embodiment, User_A obtains Session Rights Object (SRO) 220 from a source such as Origin Server 206. Note that, although specific actions and operations may be described as performed by specific devices (e.g., the Origin Server), the actions and operations can be performed by different devices and components in different embodiments. Actions and operations can be performed by one or more components and/or devices at different points in time and at different geographical locations, as desired. In general, actions, operations, functions and other effects (e.g., transfer or storage of data) described herein can be performed by one or more “processes” that include any combination of hardware and/or software, and any form of processing including processing in different times and places, using different languages, protocols, formats, etc., as desired.

In addition to the actual content, user_A obtains additional information from Cache Server 208 such as, e.g., an identification of the content, permissions for storing and accessing a local copy of the content (“persistence” rules), rules permitting superdistribution of the content, etc. The cache server is used to improve efficiency by being located at or close to an ISP operation center (e.g., at a cable headend) and storing copies of data that might be frequently requested. In some embodiments, the cache server may be a software process executing with one or more other processes in a server that also performs other functions described herein.

The SRO includes the name of License Server 110 for obtaining licenses to, e.g., play back the content. As discussed below in more detailed scenarios, an SRO can include other information such as whether or not user-to-user superdistribution is allowed. In general, the steps discussed herein with respect to FIG. 3 include authentication and permission granting by the use of tickets. These steps are omitted for ease of discussion in reference to FIG. 3 and are presented in more detail in the scenarios below. It should be apparent that any type of security mechanism can be used with any of the various steps or processing of any of the embodiment of the invention.

User_A contacts User_B for purposes of convincing User_B to access or obtain rights to the content. Such contact is typically a referral or recommendation as, e.g., word-of-mouth between friends. If User_B is interested in obtaining the content via User_A's referral, then User_A can (assuming User_A has superdistribution rights to the content) transfer an object, such as Content Referral Object (CRO) 222 to User_B along with the encrypted content, where User B does not yet have the ability to decrypt it.

In a preferred embodiment, User_A creates the CRO. The CRO includes an identification of the content to which User_B desires access, an identification of User_B and an identification of a license server that can grant access rights to User_B. User_A creates a referral key, CK, that is also encrypted with a session key. In a preferred embodiment, superdistribution is handled using the ESBroker protocol described in the referenced patent applications. In the preferred embodiment, the referral key is encrypted with an ESBroker session key that is shared with the license server through the use of an ESBroker ticket. Other embodiments can use other approaches. The referral key is included with the CRO along with any other desired information, such as a time stamp, message authentication code, etc.

In a preferred embodiment, the content includes a “preview” portion and is not encrypted. For example, a movie trailer, or a few minutes of content playback can be included as part of the preview portion. This allows User_B to play back the preview portion without obtaining any permission grants or access rights. After viewing the preview portion, User_B can decide to purchase, or otherwise subscribe to or license, the content.

User_B uses the CRO to access the Origin Server to obtain SRO 224 for the referred content. User_B then accesses the License Server and provides both the SRO and CRO information. The SRO is needed primarily for determining the set of content rights given to User B for the superdistributed content. If the original content license for User A already lists content rights that can be used after superdistribution, then the CRO will already contain the content rights for User B and thus User B can skip the step of obtaining an SRO. The License Server sends back permission and access ability (a “Key Reply”) to User_B so that User_B can access the content. The Key Reply includes the referral key generated by User_A. In the preferred embodiment the referral key is included as a subkey value, thus allowing User_B to decrypt and play back the content referred by User_A. In some embodiments, the knowledge that User_A made the referral can be used, for example, to provide User_A with some type of benefit or compensation to induce more user-to-user distribution.

The following scenarios illustrate additional various features of embodiments of the invention.

Scenario A

In the following scenario, consumer A first obtains some content with superdistribution rights and then superdistributes a copy of this content to consumer B. In this case, the content license that was issued to consumer A does not explicitly specify which content rights are allowed for superdistributed copies.
1. A Obtains a Session Rights Object (SRO) (e.g., from an Origin Server) that:
   a. Has SuperDistribution-Allowed flag set to TRUE
   b. Contains the domain name of a License Server that may issue content licenses for superdistributed copies of this content.
2. A sends a Key Request to a Cache Server and gets back a Key Reply that includes some persistence rights. These persistence rights have the SuperDistribution-Allowed set to TRUE and include a copy of the License Server domain name from the SRO.
3. A convinces B to register with the same content distribution service. In ESBroker terms, B would be registered with the KDC and will obtain a principal name.
4. B sends A its ESBroker principal name that can be used for content referrals.
5. Consumer A generates a random new subkey CK, where CK is used to derive both content encryption and authentication keys. (This step would be prudent, although the threat model does not provide a strong motivation for the content to be re-encrypted with a new key during superdistribution. Consumer A could also reuse the same CK that it is currently using for its locally stored copy of the content.)
6. Consumer A makes sure that she already has a ticket for an entity called a License Server. If not, A will use the ESBroker protocol to obtain an appropriate ticket from the KDC.
7. Consumer A generates a Content Referral object that consists of the following components:
   a. Content ID (e.g., a URI)
   b. CK encrypted with an ESBroker session key.
   c. A's ticket for the License Server. The session key in this ticket is the same one used to encrypt CK.
   d. Current time, adjusted using the ESBroker clock skew.
   e. B's principal name.
   f. A Message Authentication Code (MAC) to insure the integrity of this object. The same ESBroker session key is used as the MAC key.
8. A sends the following information to B:
   a. Content Referral
   b. Encrypted (and possibly fingerprinted and authenticated) content to B.
   c. Domain name of the License Server
   d. URL of the Origin Server (for obtaining an SRO)
9. B first renders the free preview portion of the content (if such is available). B likes the preview and decides to purchase the content.
10. B goes to the specified Origin Server in order to select possible purchase options for this content and obtains a Session Rights Object (SRO). The SRO has to include a ticket for the License Server (instead of a Cache Server). In this request for an SRO, B has to specify that it wants to obtain a license for content that it already has—so that the Origin Server knows to use a ticket for a License Server and not for a Cache Server.
11. B makes sure that it also has its own ticket for the License Server. If not, B uses an ESBroker protocol to obtain a ticket from the KDC.
12. B sends an ESBroker Key Request message to the License Server. This message includes both an SRO and a Content Referral object.
13. The License Server verifies both the SRO and the Content Referral object, logs the transaction and sends back a Key Reply to B. The Key Reply contains persistent content rights for the purchased content. The subkey value in the Key Reply is CK that was originally generated by consumer A. Since the Content Referral object contains A's ticket with A's identity, the log entry made by the License Server could be used to provide a discount or some other benefit to A.
14. Consumer B locally generates a content license for the superdistributed content (based on the persistent content rights received in Key Reply) and is now ready to consume the content.

The same License Server could be reused for other purposes as well, besides issuing licenses for superdistributed content. It could be used to:
1. Issue licenses for pre-positioned content. In this case, there is no need for a Content Referral.
2. Renew/extend an existing license. In this case, an old license would have to be included in a Key Request instead of the Content Referral object.
   Scenario B

This scenario is similar to A, except that the license issued to consumer A explicitly lists content rights that are to be associated with superdistributed copies. This same scenario also covers the case when A's content license has a flag that indicates that the License Server knows what the content rights should be for a superdistributed copy of this content.
1. A Obtains an SRO (e.g., from an Origin Server) that:
   a. Has SuperDistribution-Allowed flag set to TRUE
   b. Contains the domain name of a License Server that may issue content licenses for superdistributed copies of this content.
   c. Either has a set of content rights that are to be associated with superdistributed copies or has a flag indicating that the License Server is capable of determining those rights.
2. A sends a Key Request to a Cache Server and gets back a Key Reply that includes some persistence rights. These persistence rights have the SuperDistribution-Allowed set to TRUE and include a copy of the License Server domain name from the SRO. The content rights used for superdistributed copies are also included.
3. A convinces B to register with the same content distribution service. In ESBroker terms, B would be registered with the KDC and will obtain a principal name.
4. B sends A its ESBroker principal name that can be used for content referrals.
5. Consumer A generates a random new subkey CK, where CK is used to derive both content encryption and authentication keys. (This step would be prudent, although the threat model does not provide a strong motivation for the content to be re-encrypted with a new key during superdistribution. Consumer A could also reuse the same CK that it is currently using for its locally stored copy of the content.)
6. Consumer A makes sure that she already has a ticket for an entity called a License Server. If not, A will use the ESBroker protocol to obtain an appropriate ticket from the KDC.
7. Consumer A generates a Content Referral object. It contains the same information as in scenario A and in addition may include:
   Content rights for superdistributed content as originally specified in the SRO.
If this information is not in the Content Referral, it is expected that the License Server can determine them (e.g., based on its own database of rights associated with each content).
8. A sends the following information to B:
   a. Content Referral
   b. Encrypted (and possibly fingerprinted and authenticated) content to B.
   c. Domain name of the License Server
9. B first renders the free preview portion of the content (if such is available). B likes the preview and decides to purchase the content.
10. B makes sure that it also has its own ticket for the License Server. If not, B uses an ESBroker protocol to obtain a ticket from the KDC.
11. B sends an ESBroker Key Request message to the License Server. This message includes a Content Referral object (but no SRO).
12. The License Server verifies the Content Referral object, logs the transaction and sends back a Key Reply to B. The Key Reply contains persistent content rights for the purchased content (which may be based on the superdistribution rights listed in the Content Referral). The subkey value in the Key Reply is CK that was originally generated by consumer A. Since the Content Referral object contains A's ticket with A's identity, the log entry made by the License Server could be used to provide a discount or some other benefit to A.
13. Consumer B locally generates a content license for the superdistributed content (based on the persistent content rights received in Key Reply) and is now ready to consume the content.
   Scenario C

In scenario B, consumer A is trusted to pass on superdistribution rights to consumer B and then to a License Server as part of the Content Referral object. An authenticator for the Content Referral is generated by consumer A. However, if consumer A's software has been hacked and no longer checks the validity of content rights, consumer A could illegally generate some additional superdistribution rights.

For additional security, this scenario does not place trust in consumer A for specifying superdistribution rights to consumer B and then to the License Server. In this scenario, the Origin Server that initially generated an SRO for consumer A generated an additional authenticator for the superdistribution rights, where this authenticator can be verified by the License Server. This way, the License Server has to trust Origin Servers but not the consumers for the correctness of the superdistribution rights.
1. A Obtains an SRO (e.g., from an Origin Server). Along with the SRO, A also obtains a separate SuperDistribution Rights (SDR) object that includes content rights that are to be associated with superdistributed copies. The fact that the consumer receives this object means that superdistribution is allowed (and so an explicit flag is not needed in the SRO). The SDR includes an authenticator that is generated using a ticket for the License Server. Since the ticket includes the License Server name, the License Server name need not be listed separately in the SRO.
2. A sends a Key Request to a Cache Server and gets back a Key Reply that includes some persistence rights. These persistence rights do not include any information on superdistribution—that information is in the SDR. When consumer A locally generates a content license, the SDR is included in that license.
3. A convinces B to register with the same content distribution service. In ESBroker terms, B would be registered with the KDC and will obtain a principal name.
4. B sends A its ESBroker principal name that can be used for content referrals.
5. Consumer A generates a random new subkey CK, where CK is used to derive both content encryption and authentication keys. (This step would be prudent, although the threat model does not provide a strong motivation for the content to be re-encrypted with a new key during superdistribution. Consumer A could also reuse the same CK that it is currently using for its locally stored copy of the content.)
6. Consumer A makes sure that she already has a ticket for an entity called a License Server. If not, A will use the ESBroker protocol to obtain an appropriate ticket from the KDC.
   Consumer A generates a Content Referral object. It contains the same information as in scenario A.
7. A sends the following information to B:
   a. Content Referral
   b. Encrypted (and possibly fingerprinted and authenticated) content to B.
   d. SDR
8. B first renders the free preview portion of the content (if such is available). B likes the preview and decides to purchase the content.
9. B makes sure that it also has its own ticket for the License Server. If not, B uses an ESBroker protocol to obtain a ticket from the KDC.
10. B sends an ESBroker Key Request message to the License Server. This message includes both a Content Referral object and the SDR.
11. The License Server verifies both the SDR and the Content Referral object, logs the transaction and sends back a Key Reply to B. The Key Reply contains persistent content rights for the purchased content (based on the SDR). The subkey value in the Key Reply is CK that was originally generated by consumer A. Since the Content Referral object contains A's ticket with A's identity, the log entry made by the License Server could be used to provide a discount or some other benefit to A.
12. Consumer B locally generates a content license for the superdistributed content (based on the persistent content rights received in Key Reply) and is now ready to consume the content.

In the embodiments, above, each superdistributed copy can be individually encoded (fingerprinted and/or encrypted) in order to enable traceability of the illegally distributed copies of the content to the consumer that purchased that particular copy. Embodiments of this approach do not have to rely on a central database of content decryption keys managed by a content provider.

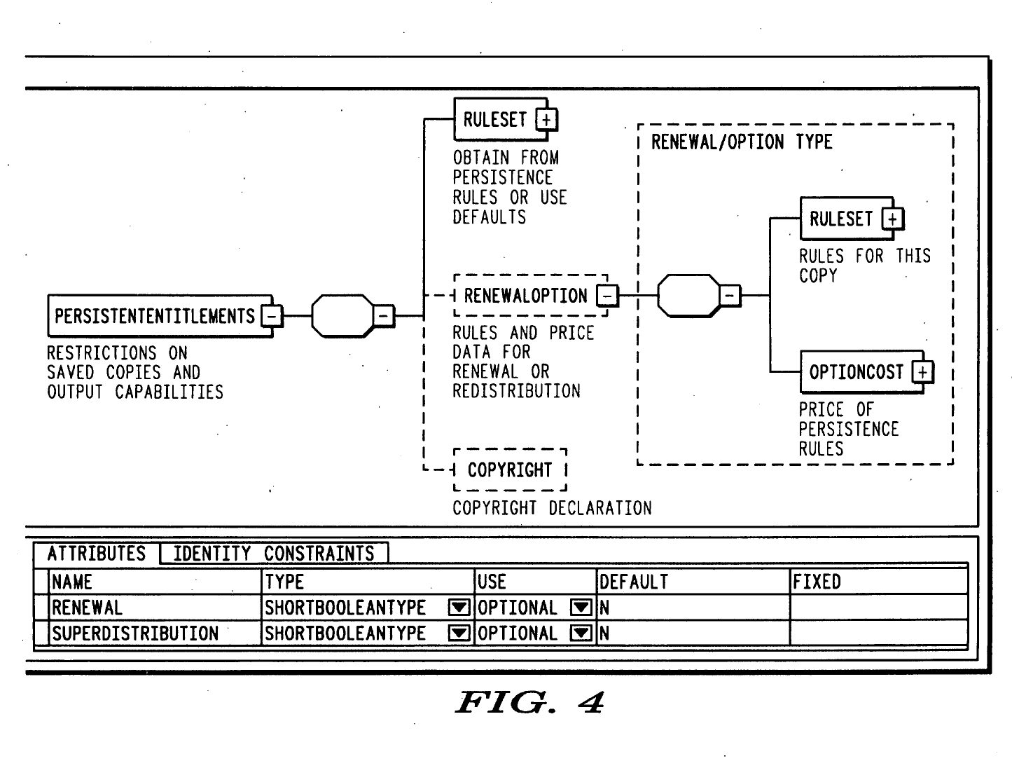

FIG. 4 is a diagram showing attributes of a PersistentEntitlements element in a preferred embodiment of the invention.

The persistent entitlement element, or object, includes a renewal attribute for allowing a content license to be renewed after the license expires. A request can be sent to a License Server to obtain a new license for already stored content. The rules that would appear in a new license after a renewal can be either taken from one of the renewal options, described below, or a new set of rules can be obtained in an SRO from an Origin Server.

The persistent entitlement object also includes a superdistribution attribute that indicates whether the corresponding content may be superdistributed to other users. These other users will obtain permission to access the content using one of the mechanisms described above, or other suitable mechanisms. The rules that appear in a new license associated with a superdistributed copy of the content can be either taken from one of the renewal options (see below) or a new set of rules can be obtained (inside an SRO) from an Origin Server.

PersistentEntitlements is also a sequence of three types of elements. (1) A RuleSet element includes a set of content usage rules and restrictions associated with the content. A RenewalOption element represents a possible set of rules that would go into a new license after. a renewal. There could be no RenewalOption elements (if the content license is not allowed to be renewed and superdistribution is not allowed) or there could be multiple RenewalOption elements for the same object in the case that the same content could be renewed under different sets of content rights, each associated with a different price.

(2) A RenewalOption includes a cost—an amount of money that would be charged to a consumer for renewing a content license with this option.

A RuleSet element of the RenewalOption has the same type as the RuleSet element of the PersistentEntitlements. However, in this case the RuleSet represents incremental changes from the original set of rules. When a renewal option is selected, the resulting set of content rules/restrictions is obtained as follows: If a particular rule or restriction is found only in the original (base) RuleSet, copy it into the new PersistentEntitlements. If a particular rule or restriction is found only in the RuleSet for the selected renewal option, copy it into the new PersistentEntitlements. If a particular rule or restriction is found in both the base RuleSet and in the RuleSet for the renewal option, take the one in the renewal option. If a particular rule or restriction is found in neither of the two rule sets, use a default value. The OptionCost element of the RenewalOption may include both the cost for license renewal using this option and a cost of superdistribution using this option (that may be different from the renewal cost).

(3) Copyright element is the copyright information associated with the content.

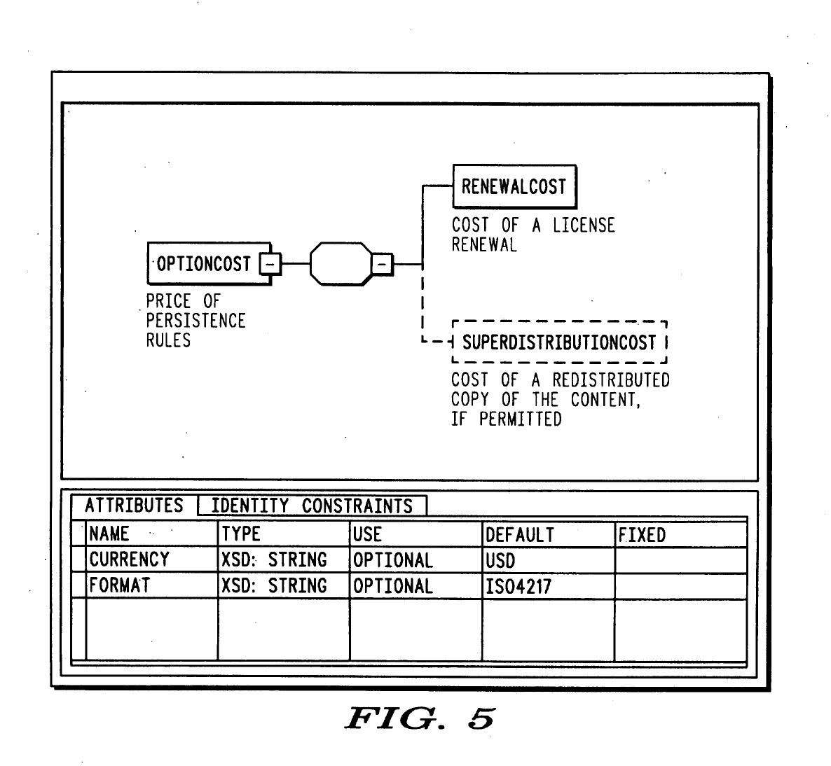

FIG. 5 is a diagram showing attributes of an OptionCost element in a preferred embodiment of the invention.

The OptionCost Element is a sequence of RenewalCost and/or RedistributionCost. RenewalCost includes the cost of renewing a license with this option that contains this set of content usage rules. RedistributionCost includes the cost of buying a superdistributed copy of the content using this option with this set of content usage rules. When this optional element is present, the same set of content usage rules may be used for both renewing a license and buying a superdistributed copy of the content. The price may be different in the two cases, e.g., a user can get a bigger discount when renewing the license to content already purchased. This element is optional as not all renewal options may also be used for superdistribution. Alternatively, some renewal options may be used only for superdistribution.

Although the invention has been discussed with respect to specific embodiments thereof, these embodiments are merely illustrative, and not restrictive, of the invention.

A ticket can vary in the amount and type of information it includes. Although a ticket at a minimum includes an identification of the requesting device and a session key, a preferred embodiment also includes a timestamp, ticket expiration time and user authorization data. A ticket may include other information as well, such as the IP address of the requesting device, security level of the requesting device, etc.

Different security approaches can be used. For example, different methods of encryption can be used. The selection of which information to encrypt or encode and the authentication and authorization methods of the present invention can be varied and still be within the scope of the invention. Other aspects of the specific embodiments presented herein can be modified.

Any suitable programming language can be used to implement the routines of the present invention including C, C++, Java, assembly language, etc. Different programming techniques can be employed such as procedural or object oriented. The routines can execute on a single processing device or multiple processors. The functions of the invention can be implemented in routines that operate in any operating system environment, as standalone processes, in firmware, dedicated circuitry or as a combination of these or any other types of processing.

Steps can be performed in hardware or software, as desired. Note that steps can be added to, taken from or modified from the steps in the flowcharts presented in this specification without deviating from the scope of the invention. In general, descriptions of functional steps, including those in tables or flowcharts, are only used to indicate one possible sequence of basic operations to achieve a functional aspect of the present invention. Steps can be performed in serial or parallel. Steps can be split up or divided among one or more processors, or performed in real-time or non-real time (e.g., “batch,” or “offline) modes.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may be any processor-containing device, such as a mainframe computer, a personal computer, a laptop, a notebook, a microcomputer, a server, or any of the like. A “computer program” may be any suitable program or sequence of coded instructions that are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” includes a system or mechanism that interprets and executes instructions (e.g., operating system code) and manages system resources. More particularly, a “processor” may accept a program as input, prepares it for execution, and executes the process so defined with data to produce results. A processor may include an interpreter, a compiler and run-time system, or other mechanism, together with an associated host computing machine and operating system, or other mechanism for achieving the same effect. A “processor” may also include a central processing unit (CPU) which is a unit of a computing system which fetches, decodes and executes programmed instruction and maintains the status of results as the program is executed. A CPU is the unit of a computing system that includes the circuits controlling the interpretation of instruction and their execution.

A “server” may be any suitable server (e.g., database server, disk server, file server, network server, terminal server, etc.), including a device or computer system that is dedicated to providing specific facilities to other devices attached to a network. A “server” may also be any processor-containing device or apparatus, such as a device or apparatus containing CPUs. Although the invention is described with respect to a client-server network organization, any network topology or interconnection scheme can be used. For example, peer-to-peer communications can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Any communication channel or connection can be used such as wired, wireless, optical, etc.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for distributing digital content, the method using a first user device in communication with a second user device and a License Server, the method comprising
using the first user device to generate a referral key;
securing the referral key so that the referral key can not be used unless information is obtained from the License Server;
creating an identifier for identifying the digital content; and
sending the secured referral key and the identifier to the second user device by using a digital object (a Content Referral Object or “CRO”);
sending the CRO from a user to the License Server
sending back a re-encrypted referral key from the License Server, wherein the re-encrypted referral key can be decrypted and utilized by the second user to decrypt the content.

2. The method of claim 1, wherein the step of securing the referral key includes a substep of
encrypting the referral key with a public key of the License Server's public key, wherein a corresponding private key is stored in the License Server.

3. The method of claim 2, wherein the referral key is encrypted with a session key and the CRO includes both the encrypted session key and a ticket issued to the first user device with that same session key, where the ticket can only be decrypted by this specific server.

4. The method of claim 1, further comprising
sending an identification of the second user device.

5. The method of claim 1, further comprising
sending an identification of a user who has access to the second user device.

6. The method of claim 1, further comprising
transferring an encrypted copy of the digital content to the second user device.

7. The method of claim 1, further comprising
sending an identification of the first user device.

8. The method of claim 1, further comprising
sending an identification of a user who has access to the first user device.

9. The method of claim 1, wherein a session rights object obtained by the first user from an Origin Server includes a permission for use of the content at the second user device.

10. The method of claim 9, further comprising
providing the session rights object by an Origin Server to the first user prior to sending the secured referral key and the identifier to the second user device.

11. The method of claim 9, further comprising
providing the session rights object from an Origin Server to the second user; and
sending both the session rights object and the CRO from the second user to the License Server, prior to the second user obtaining a re-encrypted referral key for decrypting content.

12. The method of claim 9, wherein the session rights object provided by an Origin Server to the first user includes Super Distribution Rights (SDR) with a separate authenticator that can be validated by the License Server.

13. The method of claim 12, further comprising
sending the CRO from the first user to the second user along with the SDR;
sending, from the second user, both the CRO and the SDR to a License Server; and
using the license server to validate the authenticator and the superdistribution rights contained in the SDR, decrypt and validate the CRO and return to the second user a re-encrypted referral key for decrypting content.

14. The method of claim 9, wherein an Origin Server is separate from the License Server.

15. The method of claim 9, wherein both the Origin Server and the License Server are co-hosted.

16. The method of claim 9, wherein both the Origin Server and the License Server are co-hosted and share the same principal name and service key used to decrypt tickets.

17. An apparatus for distributing digital content, the apparatus comprising
a first user device in communication with a second user device and a License Server;
a machine-readable medium in the first user device including
one or more instructions for using the first user device to generate a referral key;
one or more instructions for securing the referral key so that the referral key can not be used unless information is obtained from the License Server;
one or more instructions for creating an identifier for identifying the digital content; and
one or more instructions for sending the secured referral key and the identifier to the second user device.

18. A method for allowing content to be distributed among users, wherein the content is obtained from a first user and provided to a second user, the method comprising
operating a License Server for defining a record that indicates permitted use of the content by the second user; and
issuing a record that renews the permitted use of the content by the second user.

19. The method of claim 18, further comprising
providing a list of content rights to be associated with copies of the content distributed by the first user to other users.

20. The method of claim 19, further comprising
including an indicator in the list of content rights to indicate that content rights for the second user are stored in a record at the License Server.

21. The method of claim 18, further comprising
receiving an indication from the first user of content access rights granted to the second user.

22. The method of claim 18, further comprising
receiving a signal from the second user to indicate a request to access the content; and
granting permission for the second user to access the content.

23. The method of claim 22, further comprising
sending a referral key and identifier to the second user device.
